(19) United States
(12) Patent Application Publication
(10) Pub. No.: US 2009/0055748 A1
(43) Pub. Date: Feb. 26, 2009

(54) SYSTEM AND METHOD FOR FLEXIBLY SELECTING AND VISUALIZING CONFIGURATION CHANGES OVER TIME

(75) Inventors: Andreas Dieberger, Los Gatos, CA (US); Sandeep K. Gopisetty, Morgan Hill, CA (US); Eben M. Haber, Cupertino, CA (US); Divyesh Jadav, San Jose, CA (US); Sudir V.R. Koka, Sunnyvale, CA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/844,068

(22) Filed: Aug. 23, 2007

(51) Int. Cl. G06F 15/177

(52) U.S. Cl. 715/735

(57) ABSTRACT

A system and method for flexibly visualizing and selecting configuration changes over time is disclosed herein. The system may include a coarse selection interface configured to select one of a coarse time range and a discrete point in time from an available overall set of discrete points in time, a fine selection interface configured to select one of a fine time range and the discrete point in time from the selected one of the coarse time range and the discrete point in time, and a visualization panel configured to display a graphical representation of configuration changes selected through the fine selection interface. The method may include selecting the coarse time range on the coarse selection interface, selecting the fine time range on a fine selection interface, and visualizing the graphical representation on the visualization panel.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention generally relates to configuration changes. Specifically, this invention relates to flexibly selecting and visualizing configuration changes over time.

2. Description of Background

In storage administration (e.g., very large distributed systems) configuration changes may occur quite frequently. Due to the complexity of the systems under consideration, a change could have negative impacts on performance that may not be noticed for weeks. At that point in time it is difficult to identify a particular configuration change that may have caused the problem.

System management tools may represent states of a complex system in various levels of detail. Larger perspectives may be useful for an overview of how problematic areas of large systems relate to each other. Smaller perspectives of just particular points of a large system may provide vital information about system health or performance as well. Conventionally, it is not possible to fully address both small perspectives and larger ones because of the massive scale of systems and the ensuing information overload. Additionally, system management tools consider only the current state of the system, or the last reported state for portions of the system.

However, for many troubleshooting activities it may be important to be able to look at system state and configuration at different points in time such that the configuration, health, and performance of an earlier or future version of the system may be more accurately compared. Thus example embodiments of the present invention provide such benefits.

### SUMMARY

A system of flexibly selecting and visualizing configuration changes over time includes a coarse selection interface configured to select one of a coarse time range and a discrete point in time from an available overall set of discrete points in time, a fine selection interface configured to select one of a fine time range and the discrete point in time from the selected one of the coarse time range and the discrete point in time, and a visualization panel configured to display a graphical representation of configuration changes selected through the fine selection interface. The discrete points in time are sampled on at least one of even and uneven time intervals and represent all configuration changes occurring within a time interval between the discrete points in time, the time range is a sub-set of the overall set; the fine time range is a sub-set of the coarse time range, the graphical representation includes an overlay annotation of configuration changes to elements within the system at a selected discrete point in time, and the overlay annotation uses one of five different change states to annotate configuration changes for each element within the system at the selected discrete point in time.

A method of flexibly selecting and visualizing configuration changes over time includes selecting a coarse time range on a coarse selection interface, selecting a fine time range on a fine selection interface, and visualizing configuration changes over time on a visualization panel configured to display a graphical representation of configuration changes selected on the line selection interface. The coarse selection interface is configured to select one of a coarse time range and a discrete point in time from an available overall set of discrete points in time, the discrete points in time are sampled on at least one of even and uneven time intervals and represent all configuration changes occurring within a time interval between the discrete points in time, and the time range is a sub-set of the overall set. Additionally, the fine selection interface is configured to select one of a fine time range and the discrete point in time from the selected one of the coarse time range and the discrete point in time, and the fine time range is a sub-set of the coarse time range. Also, the graphical representation includes an overlay annotation of configuration changes to elements within the system at a selected discrete point in time, and the overlay annotation uses one of five different change states to annotate configuration changes for each element within the system at the selected discrete point in time.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a user interface of a system according to an exemplary embodiment; and

FIG. 2 depicts a visualization panel according to an exemplary embodiment.

The detailed description explains an exemplary embodiment, together with advantages and features, by way of example with reference to the drawings.

### DETAILED DESCRIPTION

According to an exemplary embodiment, a solution has been achieved which significantly increases the flexibility of visualizing and selecting configuration changes over time. This increase in flexibility results in the ability to look at system state and system configuration at different points in time such that the health of an earlier or future version of a system may be more accurately compared.

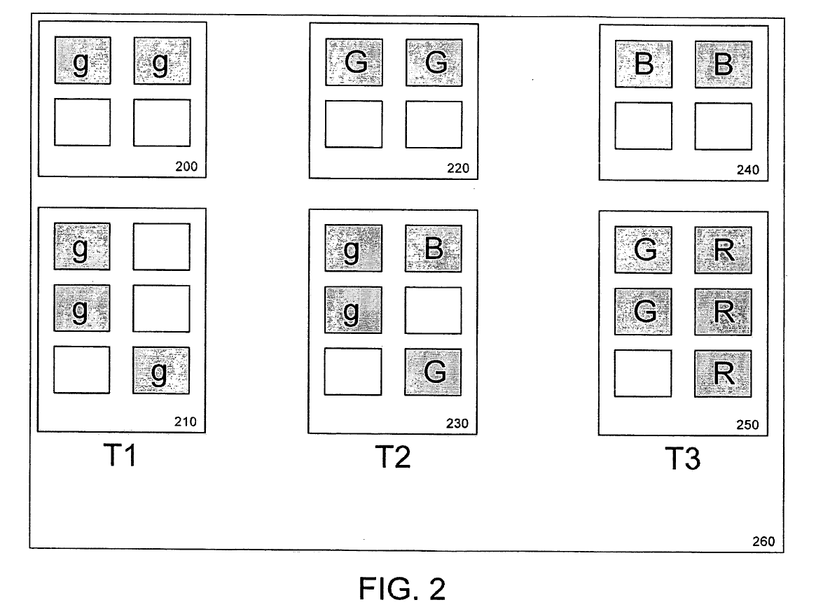

According to an exemplary embodiment, a system and a method of flexibly selecting and visualizing configuration in one of two ways. First, a system state may be represented at a specific point in time, including the present or even future states. Alternatively, at least 2 states in time may be represented (see T1, T2, and T3, of FIG. 2). The present application focuses on describing comparison of just two points in time for the sake of brevity, but it should be understood that the exemplary embodiment is applicable to single and multiple comparison points of virtually any number.

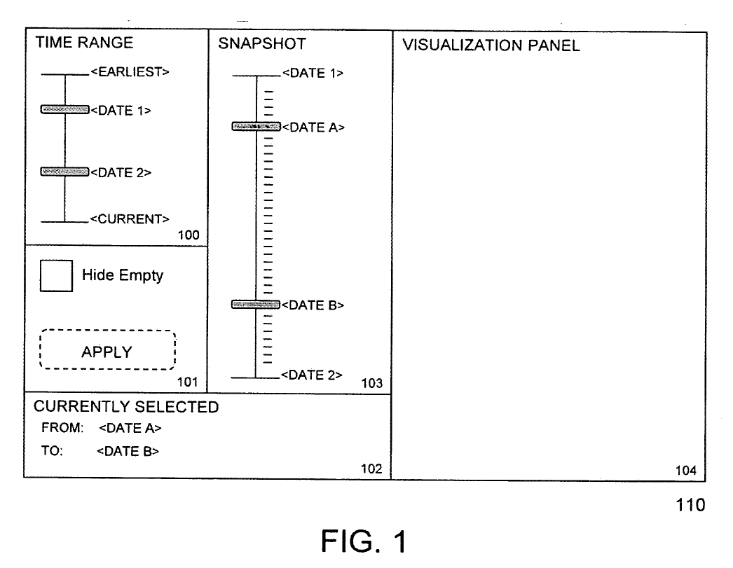

Turning to FIG. 1, a user interface of a system according to an exemplary embodiment is illustrated. As shown in FIG. 1, user interface 110 may include time range portion I 00 and snapshot portion 103. According to an exemplary embodiment, system configuration information is captured (e.g., sampled) at desired intervals. The desired intervals may be one of at least even and uneven time intervals. The configuration information is organized according to date and/or a particular time of occurrence (e.g., see the vertical time bars of portions 100 and 103). It is noted that the time bars referenced above may be arranged vertically, horizontally, or in any suitable manner. Furthermore, the inclusion of a consistent time base should also be noted.

Because of the large amount of data collected in a typical system, it may be unfeasible to continuously collect every status and configuration change as it occurs. Instead, example embodiments examine a system at a specific point in time, consider that point in time a snapshot (e.g., indexed Tn), and roll up all changes that have occurred between the last snapshot (Tn-1) and that point in time (Tn) as changes that have occurred within a discrete time slot. Therefore, the time base of an exemplary embodiment is not a continuous time line, but a set of discrete points in time that aggregate all changes that have occurred within a time interval.

For example, two slider bars on time range portion 100 may select a time range of configuration changes between <DATE 1> and <DATE 2>. The available snapshots of configuration information between <DATE A> and <DATE B> may then be selected using selection bars on the snapshot portion 103, within the time range of <DATE 1> and <DATE 2>. A graphical representation of the selection(s) on the snapshot portion 103 (i.e., visualization panel 104; and may be used with a graphical topology viewer) may be included to show the state of the configuration at one or more of the selected points in time, and may describe how each entity has changed between selected points in time.

As illustrated in FIG. 1, the slider bars of portions 100 and 103 are dynamically labeled, and it is submitted that the dynamic labels move with their respective slider bars within the interface. Snapshots may be labeled using textual descriptions highlighting key aspects of each snapshot (e.g., a line of text provided by an administrator triggering a snapshot, a description of a planning task causing changes, a summary of the changes happening, or any other suitable description). Because there is the possibility of many snapshots along the vertical time bar, only the snapshot immediately besides each of the slider bars may actually be labeled. However, according to an exemplary embodiment, interfaces including labeling for each snapshot as well should not be excluded.

Turning again to FIG. 1, slider bars within portion 100 may select a sub-range within the entire range of snapshots. The vertical time bar of portion 103 displays the sub-range selected in portion 100. Therefore, the range and/or spacing of snapshots on the vertical time bar of portion 103 changes dynamically as the slider bars within portion 100 move. Further, as the sub-range is adjusted, the vertical time bar of portion 103 updates to represent the entire sub-range indicated by the slider bars of portion 100.

As the slider bars of portion 103 are moved, they make a sub-selection within the sub-range (fine-grain or fine adjustment). The tick marks on the vertical time bar of portion 103 indicate the number of snapshots available in the sub-range. As portion 100 is adjusted, this number may change and the number of tick marks should update accordingly (coarse-grain or coarse adjustment). In this manner, a user may explore the overall range of snapshots and select a sub-range with the desired granularity of snapshots available for portion 103. Subsequently, the user may further adjust the slider bars on portion 103.

Therefore, the control is split into a coarse-grain and a fine-grain range selection interface which makes it possible to make fine selections of shorter time ranges (snapshot portion 103) within a larger time range (time range portion 100), and may have the finer selections displayed on a visualization panel 104. Upon selection of a time range in portion 103, the visualization panel 104 may be updated to reflect the requested time range.

Additionally, in some systems there may be latency between a selection of a range in the controls (i.e., portions 100, 101, and 103) and actual display of the change within the visualization panel 104. In such a situation, the time range currently shown in the visualization panel 104 (topology viewer) may deviate from the time range indicated by the slider position (e.g., if a user moves the slider bars). Therefore, “Currently Selected” field indicates what is currently shown in the visualization panel 104 (see portion 102). To further indicate this possible discrepancy, additional markers may be provided on the vertical time bars of portions 100 and 103 to indicate what is actually shown in the current topology view (i.e., visualization panel 104). Additionally an “Apply” button (see portion 101) may be included. According to an exemplary embodiment, if the “Apply” button is selected, the visualization panel 104 is updated. Therefore, according to an exemplary embodiment, a method of compensating for discrepancies between selections on portions 100 and 103 and the current state of the visualization panel 104 is provided.

Split slider bars may also be included (although not illustrated) in example embodiments. According to these example embodiments, a split slider is included on a vertical time bar of one of portions 100 and 103. The split slider may be represented by a set of two triangles. Moving the two sliders on the same spot would, visually, make the two sliders form one triangle that indicates one point in time. In this manner, both sliders may be moved to the same point and the selection becomes a point selection in time rather than a time range. Therefore, according to the particular sliders used for selection, a user may select only a particular point in time or a range in time.

Skip or jump buttons may also be included (although not illustrated) in example embodiments. According to these example embodiments, skip or jump buttons may be included in interface 110. The skip or jump button(s) may be represented by a button (or buttons) which allows a user to skip forward or backwards through configuration changes on either of portions 100 and 103. Therefore, through inclusion of skip or jump buttons, a user may actively traverse different points or snapshots. Further, through use of filtering (described below) in combination with skip or jump buttons, users may actively skip or jump through snapshots of a particular filter type.

As described above, according to an exemplary embodiment, a tool is provided for exploring snapshots of configuration changes of a complex system. The user may select a single snapshot (i.e. one slider or split triangle sliders) to focus on, or select two or more snapshots (i.e. two or more slider bars).

Additional tools may be included to control filtering and/or search of snapshots if they are/are not relevant to the user. For example, in one aspect, a control may be used to filter (hide) all snapshots that do not contain any changes (see “Hide Empty” filter checkbox of portion 101 According to other aspects, all those snapshots that do not contain changes of a specific type or that are not tagged with specific types of information. Therefore, in addition to the “Hide Empty” filter checkbox, other types and methods of filtering may be included through the use of other checkboxes or textual search fields, without departing from the exemplary embodiment.

As mentioned above, it may be useful for users to filter the number of snapshots to actually display. Additional filtering solutions may include filtering empty snapshots, filtering based on type of change, filtering based on an amount of change, filtering based on tagging (e.g., textual description described above), filtering based on a user whom created the snapshot (i.e., administrator name or user logged into system), filtering within a given or desired time range (selected on portions 100 and/or 103, or otherwise), and/or filtering based on a general search for text or description.

As an example of additional filtering, to filter based on amount of change, it is noted that according to an exemplary embodiment, a histogram may be used to represent the amount of change. Thus, a histogram may be drawn both on the left and right of a vertical time bar to indicate the amount of change of two different types, and marks along the vertical time bar may indicate presence of a third criterion for that snapshot, such as a textual description or time delay. Further, different colors and/or markers including bar graphs, ticks, text, et cetera could be included to provide even more information along the vertical time bars. However, for the sake of simplicity of the drawings and brevity of this description, exhaustive description of the plurality of combinations of filtering techniques possible will be omitted. Hereinafter, a description of how changes are indicated according to an exemplary embodiment is explained in detail with reference to FIG. 2.

FIG. 2 depicts a visualization panel 260 according to an exemplary embodiment. For simplicity, elements in FIG. 2 are shown as boxes, and box letter identifiers are provided to indicate the change state of particular elements. Each element shown may have one of at least five states with respect to the change state when comparing an earlier (T1) and a later (T2) snapshot. The five states may include: no change for the entity between point T1 and T2; the entity has been newly created between T1 and T2; the entity has been deleted between T1 and T2; the entity has been modified between T1 and T2; and the entity didn't exist at either point in time.

In FIG. 2, “g” denotes that an element does not exist, “G” denotes that an element is new, “R” denotes that an element is deleted, and “B” denotes that an element has been modified. In some example embodiments, the elements are represented in color, with the actual color indicating the change state of the element: gray (does not exist), green (new), red (deleted) and blue (modified). However, for simplicity in the drawings, only description of the letter identifiers has been included in this detailed description.

The description so far has only described situations involving present and past states. However, a future snapshot may be defined which depicts system states after certain configuration changes are applied. The current configuration may be compared with this future snapshot, or a snapshot in the past may be compared with the future snapshot. It is noted that comparing a future or planned scenario with a past snapshot may be used to reliably revert to an earlier configuration of the system. For example, an administrator would use example embodiments to identify all changes between the earlier point in time and the desired future configuration and continue making changes until the two snapshots become identical.

Turning again to FIG. 2, if a time range is selected, visualization panel 260 shows the system configuration at the later point in time and indicates for every part of the system in what ways the configuration changed between the earlier and the later point in time within the selected range. This indication of change may be represented using a graphical annotation (called “overlay”).

An overlay is a method to annotate elements in a representation, such as a topology with meta-information. The overlay may be used to indicate change status. If displaying just one point in time there is no change to indicate. However, if comparing two points in time, every element may exist is one of the five states outlined above, within the time period under consideration. Because the change status is represented using an overlay, a collapsed group of elements will aggregate change status. In example embodiments, a collapsed group shows a tally of added, removed, and modified elements within the group to provide more information on the actual changes. In an exemplary embodiment, each snapshot is further annotated with additional information describing the point in time. For example, when an administrator makes modifications to the system, the administrator can provide a short note summarizing those changes. Such a note may be kept within the snapshot, and would expose this information. For example, a note may include that an administrator added “all the configuration changes we did when the new DS8000 was installed” and/or “I subsystem added, 50 zone changes”. Therefore, a textual search for added subsystems or “DS8000” would help compare snapshots involving these terms.

Another aspect of an exemplary embodiment involves identity of elements in the representation. Each element may have a unique identifier, such as a WWN (World-Wide Name; similar to a MAC-address for ethernet cards) that should not change. If an element gets renamed, example embodiments may indicate that the element has been changed. If there is no unique identifier and the element gets renamed, it may be necessary to treat the renamed element as a new element.

Turning again to FIG. 2, a more detailed explanation of visualization of changes, in light of the discussion above, is given hereinafter. FIG. 2 depicts three snapshots or points in time, T1, T2, and T3. Each snapshot contains ten elements under comparison. It is submitted that element groups 200 and 210 represent element groups 220 and 230 at time T1; element groups 220 and 230 represent element groups 240 and 250 at time T2; and, element groups 240 and 250 represent element groups 200 and 210 at time T3. As depicted at time T1, there are 5 elements that do not exist (see 200 and 210, elements labeled “g”).

When comparing T1 and T2 changes become more noticeable. For example, three of the previously non-existent elements have been added at time T2 (see 220 and 230, elements labeled “G”), and one existing element is being modified (see 230, element labeled “B”).

At a later point in time things, even more changes are noticeable. For example, two elements created at time T2 are modified at time T3 (see 240, elements labeled “B”), three previously existing elements have been deleted (see 250, elements labeled “R”), and two previously non-existing elements have been created (see 250, elements labeled “G”). Therefore, if there is a problem with system operation occurring across any of points T1-T3, the system states may be compared directly to aid in identifying the change which caused the problem.

As noted above, changes may be denoted using the box letter identifiers. There are many of other possible representations of change state, such as a change overlay icons, colors, and/or any suitable indicator. Further, also applicable is a tabular representation of the same information. For example, columns of a table may indicate the change state using a label and/or icon. Additionally, the table may contain more detailed information such as status of a system performance parameter if appropriate. For example, textual descriptions of major changes may be included in the table, and/or other identifiers may be added. It is submitted that both the graphical representation described above may be combined with a tabular representation for a more detailed comparison. For example, a table may be displayed within a different portion of visualization panel 260 alongside the graphical representation.

While an exemplary embodiment has been described, it will be understood that those skilled in the art, both now and in the future, may make various improvements and enhancements which fall within the scope of the claims which follow. These claims should be construed to maintain the proper protection for the invention first described.

What is claimed is:

1. A system for flexibly visualizing and selecting configuration changes over time, the system comprising:
a coarse selection interface configured to select one of a coarse time range and a discrete point in time from an available overall set of discrete points in time, wherein,
the discrete points in time are sampled on at least one of even and uneven time intervals and represent all configuration changes occurring within a time interval between the discrete points in time, and
the time range is a sub-set of the overall set;
a fine selection interface configured to select one of a fine time range and the discrete point in time from the selected one of the coarse time range and the discrete point in time, wherein,
the fine time range is a sub-set of the coarse time range; and
a visualization panel configured to display a graphical representation of configuration changes selected through the fine selection interface, wherein
the graphical representation includes an overlay annotation of configuration changes to elements within the system at a selected discrete point in time, and
the overlay annotation uses one of multiple different change states to annotate configuration changes for each element within the system at the selected discrete point in time.

2. The system of claim 1 wherein:
the coarse selection interface includes a time bar representation of the overall set of discrete points in time; and
the time bar includes a consistent time base of the overall set of discrete points in time.

3. The system of claim 1 wherein:
the fine selection interface includes a time bar representation of the coarse time range;
the time bar includes tick marks representing each discrete point in time within the coarse time range; and
the time bar is dynamically updated based on updates to the coarse time range.

4. The system of claim 1 wherein:
the visualization panel is further configured to display a tabular representation of configuration changes;
the tabular representation includes textual description of states of elements within the system at the selected discrete point in time.

5. A method for flexibly visualizing and selecting configuration changes over time, the method comprising:
selecting a coarse time range on a coarse selection interface, wherein,
the coarse selection interface is configured to select one of a coarse time range and a discrete point in time from an available overall set of discrete points in time,
the discrete points in time are sampled on at least one of even and uneven time intervals and represent all configuration changes occurring within a time interval between the discrete points in time, and
the time range is a sub-set of the overall set;
selecting a fine time range on a fine selection interface, wherein,
the fine selection interface is configured to select one of a fine time range and the discrete point in time from the selected one of the coarse time range and the discrete point in time, and
the fine time range is a sub-set of the coarse time range; and
visualizing configuration changes over time on a visualization panel configured to display a graphical representation of configuration changes selected on the fine selection interface, wherein
the graphical representation includes an overlay annotation of configuration changes to elements within the system at a selected discrete point in time, and
the overlay annotation uses one of multiple different change states to annotate configuration changes for each element within the system at the selected discrete point in time.

6. The method of claim 5, further comprising:
taking snapshots of the configuration changes on the at least one of even and uneven time intervals;
organizing the snapshots to form the overall set of discrete points in time based on a consistent time base; and
updating the coarse selection interface based on newly taken snapshots.
